(19) United States
(12) Patent Application Publication
(10) Pub. No.: US 2006/0170953 A1
(43) Pub. Date: Aug. 3, 2006

(54) Information processing method, information processing system, information processing device and recording medium

(76) Inventors: Yuji Okamoto, Souraku-gun (JP); Katsuyoshi Fujiwara, Sennan-gun (JP); Naofumi Ueda, Souraku-gun (JP); Syounchirou Yoshiura, Ikoma-gun (JP)

Correspondence Address: NIXON & VANDERHYE, PC, 901 NORTH GLEBE ROAD, 11TH FLOOR, ARLINGTON, VA, 22203, US

(21) Appl. No.: 10/548,587

(22) PCT Filed: Mar. 16, 2004
(86) PCT No.: PCT/JP04/03506

§ 371 Date: Sep. 12, 2005

(30) Foreign Application Priority Data
Mar. 20, 2003 (JP) 2003-078756

(51) Int. Cl. G06F 3/12

(52) U.S. Cl. 358/1.15

(57) ABSTRACT

When there is a request for acquisition of a printer driver from a client apparatus, a management server acquires device configuration information of each printer apparatus, and makes a judgment of a security level of each printer apparatus as well as makes a judgment of a confidentiality level of data to be handled by a user by referring to a user management table. A printer apparatus determines a printer apparatus to be recommended for the user and the determined information is transmitted to the client apparatus. When a printer apparatus to be used by the client apparatus is selected, a printer driver of the selected printer apparatus is transmitted from the management server to the client apparatus.

### CROSS-REFERENCE TO RELATED APPLICATIONS

This application is the national phase under 35 U.S.C. §371 of PCT International Application No. PCT/JP2004/003506 which has an International filing date of Mar. 16, 2004 and designated the United States of America.

### TECHNICAL FIELD

The present invention relates to a method of information processing, an information processing system, an information processing apparatus, and a computer readable memory medium in which a computer program for realizing this information processing system and the information processing apparatus is recorded that enable to set an information device, which is recommended according to a user.

### BACKGROUND ART

A system that shares an image forming apparatus from a plurality of information processing apparatuses by connecting an information processing apparatus and an image forming apparatus such as a printer, and a multi-function machine has been proposed and introduced in offices etc. This is primarily to deal with speeding up of the image forming apparatus as well as because the processing capacity of image forming serially has been installed by accepting a plurality of jobs without stagnation by installing an internal storage device in the image forming apparatus. Moreover, as the introduction of the information processing apparatus advances gradually and the number of users over the communication network increases, since it goes beyond the processing capacity of the image forming apparatus, a new image forming apparatus is added according to the requirement.

Moreover, regarding data that is outputted according to instructions from the information processing apparatus, special emphasis has been placed on security of data of a company and of an individual. Therefore, a system that encrypts print data that is transmitted between the image forming apparatus and the information processing apparatus in the communication network has been proposed. Moreover, a so called confidentiality printing function in which printing jobs received at the image forming apparatus are allowed to be stagnated temporarily and the print out is started by password authentication has been installed in the image forming apparatus (for example, Japanese Patent Application Laid-open No. 2001-306273).

Furthermore, in recent years, a storage device such as an HDD device (HDD: Hard Disk Drive) is installed in the image forming apparatus and print data that is to be processed can be stored temporarily. At this time, the confidentiality is protected by making the reading difficult either by deleting data at a stage where the process is completed or by overwriting by random data (for example, Japanese Patent Application Laid-open No. 59-50660 (1984)). By this, even in a case where the internal storage device mentioned earlier is taken away by someone, illegal fetching of data is prevented.

Furthermore, a system in which data that is handled in the image forming apparatus is encrypted and a print out is taken by decryption has been proposed.

### DISCLOSURE OF THE INVENTION

Thus, in an environment where such various image forming apparatuses are connected over a communication network, for connecting a new information processing apparatus and using the image forming apparatus via the communication network, upon knowing by a user or a communication network manager in advance as to which image forming apparatus can be used, installation of an appropriate driver program in the information processing apparatus is sought. Particularly, in a case of handling data that is confidential according to a business operation, at this time it is desirable that a setting is made such that a request for a printing process can be made to an image forming apparatus in which a security function for data as described earlier is installed.

However, under the current circumstances, since it is not known as to which image forming apparatus is appropriate, in many cases a setting is made to enable the use of an image forming apparatus that is easily accessible, and there is a problem that it is difficult to know in advance as to whether the easily accessible image forming apparatus has such a security function or not.

The present invention is made in view of this problem and it is an object of the present invention to provide a method of information processing, an information processing system, an information processing apparatus, and a computer readable memory medium in which a computer program for realizing this information processing system and information processing apparatus is recorded that make it easy to select an appropriate information device by structuring to select the information device to be recommended for use corresponding to a received search request when the search request for the information device is received, based on device information that is stored in advance and to transmit the device information of the selected information device.

Another object of the present invention is to provide an information processing system and a computer readable memory medium in which a computer program for realizing this information processing system is recorded that enable to make it easy to select an appropriate information device according to the user, by structuring to select an information device to be recommended for use based on user information related to the user of the information processing apparatus and the device information.

Still another object of the present invention is to provide an information processing system and a computer readable memory medium in which a computer program for realizing this information processing system is recorded that enable to make it easy to select an appropriate information device according to the confidentiality of information that is handled by the user by structuring such that the device information includes information related to a security function for information that is processed by the information device.

The method of information processing according to the present invention, that is a method of information processing in which device information of one or a plurality of information devices is stored and the device information is transmitted according to a request that is received from outside, is characterized by receiving a search request for information device, selecting an information device to be recommended for use according to a requester of the received search request based on the stored device information, and transmitting device information of the selected information device to the requester.

In the present invention, when a search request for information device is received, the information device to be recommended for use according to the requester of the received search request is selected by the stored device information related to information device and the device information of the selected information device is transmitted. Therefore, it is possible to provide an information device that is suitable for the requester of the search request and an existence of an appropriate information device can be checked without checking each information device on a search request side.

The information processing system according to the present invention is characterized by being formed by connecting a first and a second information processing apparatus and one or a plurality of information devices via a communication line, the first information processing apparatus includes a storage means for storing data information related to information equipment, in the information processing system that transmits the equipment information according to the request from the second information processing apparatus, the second information processing apparatus includes means for transmitting a search request for searching an information device to be recommended for use according to the first information processing apparatus, the first information processing apparatus includes a means for receiving the search request transmitted from the second information processing apparatus and selecting means for selecting an information device that recommends use to a requester of the received search request based on the device information stored in the storage means, and device information of the selected information device is preferably transmitted to the requester.

In the present invention, when a search request for information equipment to be used is received via the communication line, the information device that recommends use to the requester of the search request is selected based on device information stored in advance and device information of the selected information device is transmitted to the requester. Therefore, it is possible to provide an information device that is suitable for the requester of the search request and an existence of an appropriate information device can be easily checked without checking each information device on the search request side.

The information processing system according to the present invention is characterized by further including means for storing user information about user of the first information processing apparatus and the second information processing apparatus, the selecting means preferably selects the information device that recommends based on user information and the device information that is stored in the storage means.

In the present invention, since the information equipment to be recommended is selected based on the user information about the user of the second information processing apparatus and the device information, it is possible to provide an information device that is suitable for the user and information of appropriate information device can be acquired without checking each information device via the communication line on a user's side.

The information processing system according to the present invention is characterized by the device information including information related to the security function for information to be processed by the information device.

In the present invention, the information related to the security function for the information to be processed is included in the device information. Therefore, it is possible to provide an appropriate information device according to the confidentiality of the information that is handled by the user and information related to information device can be acquired without checking each information device that has a security function for the information on the user's side.

The information processing system according to the present invention is characterized by first information processing unit further including means for storing setting information to be set when the second information processing apparatus uses the information device and means for transmitting the setting information to the second information processing apparatus.

In the present invention, setting information such as a driver program that is to be set when information device is used, is stored and this setting information can be transferred according to the requirement. Therefore, it is easy to acquire information of an appropriate information device without checking each information device via the communication line on the user's side, as well as to acquire setting information that is required when that information device is used.

The information processing system according to the present invention is characterized by the information device including means for receiving image data and means for performing image forming on a sheet based on the received image data.

In the present invention, the information device includes means for performing image forming based on the received image data. Therefore, for an image forming apparatus such as a printer that is connected to the communication line, it is possible to provide information suitable for use by the user and to acquire easily information of the image forming apparatus that suits an object of the user, without checking each image forming apparatus via the communication line on the user's side.

The information processing system according to the present invention is characterized by the information device including means for creating image data upon reading an image on a document and means for transmitting the created image data to outside.

In the present invention, the information device includes means for transmitting the image data created upon reading the image on the document. Therefore, for an image forming apparatus such as a network scanner that is connected to the communication line, it is possible to provide information suitable for use by the user and to acquire easily information of the image forming apparatus that suits an object of the user, without checking each image forming apparatus via the communication line on the user's side.

The information processing apparatus according to the present invention is characterized by enabling one or a plurality of information devices via the communication line, including storage means for storing device information related to connected information device, the information processing apparatus that transmits said device information corresponding to a request from the outside, including means for receiving the search request for information device and means for selecting the information device to be recommended for use according to a requester of the search request based on the data information stored in the storage means, and the equipment device of the selected information device is preferably transmitted to the requester.

In the present invention, when a search request for the information device to be used is received via the communication line, the information device to be recommended for use according to the requester of the search request is selected based on the device information stored in advance and device information of the selected information device is transmitted to the requester. Therefore, it is possible to provide an information device that is suitable for the requester of the search request and the existence of the appropriate information device can be easily checked without checking each information device on the search request side.

A computer readable memory medium according to the present invention in which a computer program is recorded that causes a computer to execute a step of transmitting the device information related to the information device stored in advance based on the received request is characterized by causing the computer to execute a step of selecting the information device to be recommended for use according to the a requester of the received search request based on the stored device information and causing the computer to execute a step of to transmitting the information of the selected information device to the requester.

In the present invention, when the search request for the information equipment to be used is received, the information device to be recommended for use according to the requester of the search request is selected based on the device information stored in advance and the device information of the selected information device is transmitted to requester. Therefore, it is possible to provide an information device suitable for the requester of the search request and the existence of the appropriate information device can be easily checked without checking each information device on the search request side.

A computer readable memory medium according to the present invention in which the computer program is recorded that causes a computer to execute a step of transmitting the device information related to the information device stored in advance based on the received request is characterized by causing the computer to execute a step of selecting the information device to be recommended for use according to a requester of the received search request based on the user information of the requester that is stored in advance and the device information and causing the computer to execute a step of transmitting the device information of the selected information device to the requester.

In the present invention, since the information device to be recommended is let to be selected based on the user information and the device information, it is possible to provide the information device appropriate for the user and to acquire information of the appropriate information device without checking each information device on the user's side.

The computer readable memory medium according to the present invention is characterized by the device information including information related to the security function for the information that is to be processed by the information device.

In the present invention, the information related to the security function for the information that is to be processed is included in the device information. Therefore, it is possible to provide an appropriate information device according to the confidentiality of the information that is handled by the user and to acquire the information related to the information device without checking each information device that has the security function for information on the user's side.

### BRIEF DESCRIPTION OF THE SEVERAL VIEWS OF THE DRAWINGS

FIG. 1 is a schematic diagram describing an overall configuration of an information processing system according to the present embodiment;

FIG. 2 is a block diagram describing an internal configuration of a printer device;

FIG. 3 is a conceptual diagram showing an example of a system management table;

FIG. 4 is a flow chart describing a process while updating the system management table;

FIG. 5 is a block diagram describing an internal configuration of a management server;

FIG. 6 is a conceptual diagram showing an example of a user management table;

FIG. 7 is a conceptual diagram showing a list of device configuration information of the management server;

FIG. 8 is a block diagram describing an internal configuration of a client apparatus;

FIGS. 9A to 9G are schematic diagrams describing an operation in a printer search program that is installed in the client apparatus;

FIG. 10 is a schematic diagram showing a print-setting screen;

FIG. 11 is a schematic diagram showing the print-setting screen;

FIG. 12 is a schematic diagram showing the print-setting screen;

FIG. 13 is a schematic diagram showing the print-setting screen; and

FIGS. 14A and 14B are flow charts describing a processing procedure of the information processing system according to the present embodiment.

### BEST MODE FOR IMPLEMENTING THE INVENTION

The present invention is described below concretely based on diagrams showing an embodiment.

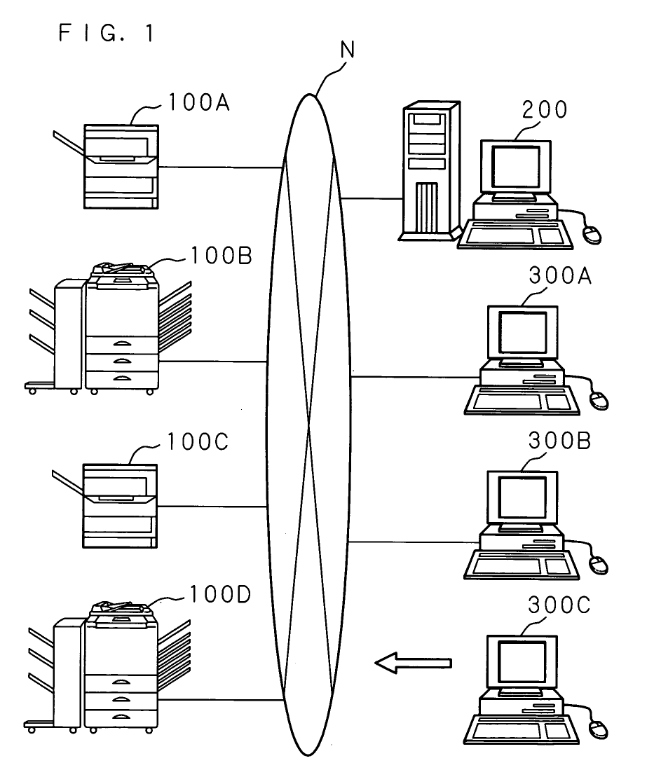

FIG. 1 is a schematic diagram describing an overall configuration of an information processing system according to the present embodiment. In the diagram, 100A to 100D are printer devices or multi-function devices that have a plurality of image processing functions (hereinafter, called as printer device 100 when there is no need to distinguish the printer devices 100A to 100D), and a management server 200 which manages the entire system and client apparatuses 300A and 300B such as a personal computer are connected via a communication network N. A printer driver of the printer device 100 that serves a purpose of a user is installed in advance in the management server 200 and the client apparatuses 300A and 300B, and an image forming can be performed on a paper by transmitting a printing job that includes image data and document data created in the management server 200 and the client apparatuses 300A and 300B to the desired printer device 100.

Moreover, the management server 200 has information related to a device configuration of the printer device 100 that exists on the communication network N and the printer driver of each printer device 100, and while connecting newly a client apparatus 300C such as a personal computer to the communication network N, information of the printer device 100 to be recommended to a user of the client apparatus 300C is provided from the management server 200 as well as the printer driver of the printer selected in the client apparatus 300C is provided from the management server 200.

Further, in the present embodiment, although the printer device 100 is let to be an information device that is used by the management server 200 and the client apparatuses 300A and 300B via the communication network N, it may be a so called network scanner device or a facsimile device that includes an image reading means and means that for transmitting image data acquired by the image reading means. Moreover, the information device that can be used in the present information processing system need not necessarily have the image processing means described earlier, and can be used in a storage device such as an HDD device that can be shared over the communication network, and a relay device that relays data between different networks.

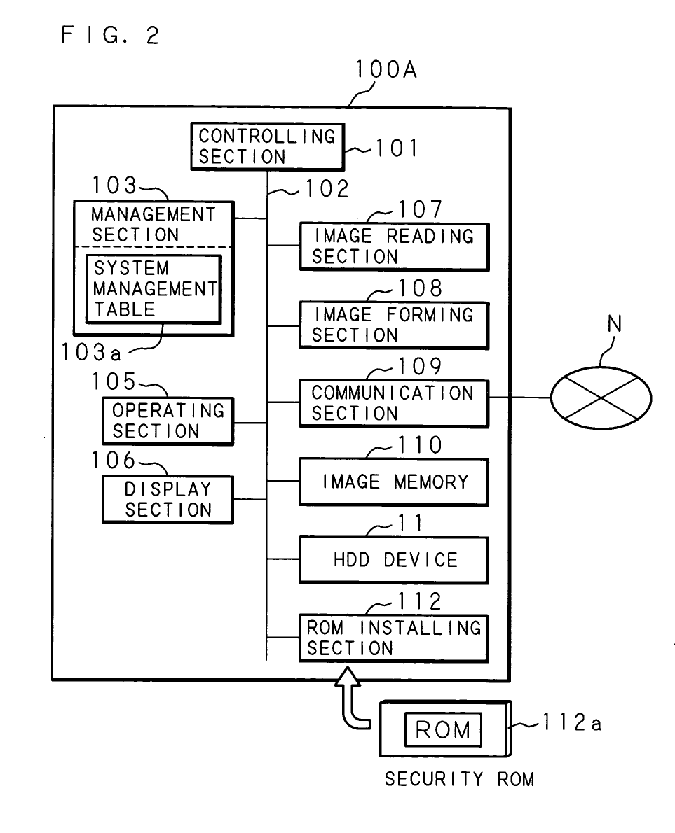

FIG. 2 is a block diagram describing an internal configuration of the printer device 100A. The printer device 100A includes a controlling section 101 that has a CPU, and the controlling section 101 controls hardware such as a management section 103, an operating section 105, a display section 106, an image reading section 107, an image forming section 108, a communication section 109, an image memory 110, and an HDD device 111, and a ROM installing section 112, which are connected via a bus 102.

The management section 103 includes a non-volatile memory and a control program for controlling each hardware mentioned earlier is stored in a part of a storage area of the non-volatile memory. The controlling section 101 controls the hardware by reading and executing the control program, and operates as an unit that performs image forming etc. as a whole. Moreover, the management section 103 has a system management table 103a that stores information related to a configuration of the hardware that is installed (device configuration information) and information related to a status inside the device (status information) and acquires the device configuration information by performing communication with each hardware when a power supply is put on, as well as updates storage content of the system management table 103a whenever necessary, when there is a change in a status upon monitoring status of each hardware during the operation.

The operating section 105 includes various operation keys (not shown in the diagram) for receiving operation instructions from the user, and receives an input such as an operation of switching function of the printer device 100A, number of prints, and copy density. The display section 106 includes a liquid crystal display or an LED display, and an operating condition of the printer device 100A and various set values that are inputted from the operating section 105 are displayed. Moreover, a part of the display section 106 includes touch panel type software keys and may be structured to receive the various settings described earlier.

The image reading section 107 includes a light source that irradiates light on the document, an image sensor such as a CCD (Charge Coupled Device), and an AD converter (not shown in the diagram), and an image of a document that is set in a predetermined reading position is caused to be formed on the image sensor and converted into an analog electric signal, the converted analog electric signal is subjected to an AD conversion by the AD converter. Further, a digital signal obtained by AD conversion, upon being subjected to correction such as correction of light-distribution characteristics of the light source while reading the document and an unevenness in sensitivity of the image sensor, is created as digital image data.

The image forming section 108 includes charger that charges a photosensitive drum to a predetermined electric potential, a laser writing unit that creates an electrostatic latent image on the photosensitive drum by emitting a laser beam according to the image data received from outside, a developing unit that visualizes the electrostatic latent image formed on a surface of the photosensitive drum by supplying a toner, and a transferring unit (not shown in the diagram) that transfers a toner image formed on the surface of the photosensitive drum to a paper, and can form an image desired by the user on the paper by electrophotography.

Further, in the present embodiment, although the image forming section 108 is structured to perform the image forming by electrophotography in which the laser writing unit is used, the image forming section 108 may as well be structured to perform the image forming by an inkjet method, a thermal transferring, and a sublimation method.

The communication section 109 includes a communication interface that conforms to communication standards of the communication network N, and receives job for executing various processing from the management server 200 and the client apparatuses 300A and 300B that are connected to the communication network N. Moreover, when the printer device 100A is to be used as the so called network scanner, the image data of the document that is obtained by the image reading section 107 is transferred to any of the management server 200 or the client apparatuses 300A and 300B via the communication section 109. The communication section 109 controls transmission and receiving of various jobs and image data etc.

The image memory 110 includes a semiconductor memory and stores temporarily data such as image data that is created upon reading the image on the document by the image reading section 107 and image data that is developed from the printing job received via the communication section 109. The temporarily stored image data in the image memory 110 is transferred according to a purpose of use to the image forming section 108, the communication section 109, or the HDD device 111 at a timing indicated by the controlling section 101. In other words, when the image forming is performed on a paper, the image data is transferred to the image forming section 108, when it is to be used as the network scanner, the image data is transferred to the communication section 109, and when it is to be saved for using afterwards, the image data is transferred to the HDD device 111.

The HDD device 111 is a storage device that has a magnetic memory medium in the form of a disc and stores image data that is subjected to output process at the image forming section 108 etc. as process-history data. Further, when image data that is outputted once is to be outputted once again additionally due to a shortage of setting of number of output copies etc., by providing an instruction from the operating section 105 in the printer device 100A or the management server 200 or the client apparatuses 300A and 300B that are connected via the communication network N, it is possible to read the required image data from the HDD device 111 and to perform the image forming once again by transferring to the image forming section 108.

Furthermore, the printer device 100A according to the present embodiment includes the ROM installing section 112 for adding a security function for data that is handled inside and when a security ROM 112a is installed in the ROM installing section 112, the data that is handled inside is protected by encrypting or invalidating.

In the encryption of the data, after the image data that is inputted via the image reading section 107 or the communication section 109 is encrypted, the image data is stored in the image memory 110 or the HDD device 111. Then, when there is an instruction for image forming from the controlling section 101 and the image data is transferred to the image forming section 108, the image data is decrypted and used. Moreover, in invalidating the data, when the output process by the image forming etc. is completed, image data for overwriting that is created by random numbers is overwritten repeatedly for a predetermined number of times on the image data that is stored in the image memory 110 or the HDD device 111. Thus by encrypting or invalidating the image data handled inside, even in a case where some one has taken away the image memory 110 or the HDD device 111, it becomes difficult to reproduce the stored data and it is possible to secure the confidentiality of the data.

Moreover, the printer device 100A has a function of performing a confidentiality process as another means of securing the confidentiality of the data. In the confidentiality process, when a printing job is received, image is not formed on a paper and outputted immediately, but input of a predetermined password by a specific user from the operating section 105 is awaited, and the image forming is started when the user is authenticated to be the specific user by the input password, and a paper with the image formed on it is outputted.

Further, the printer devices 100B to 100D, when compared with the printer device 100A, although differs at points such as to whether the security ROM 112a is installed or not, whether the confidentiality function is available or not, and the possibility of the processing capacity and color printing, since the basic internal structure is similar to an internal structure of the printer device 100A, the detailed description is omitted.

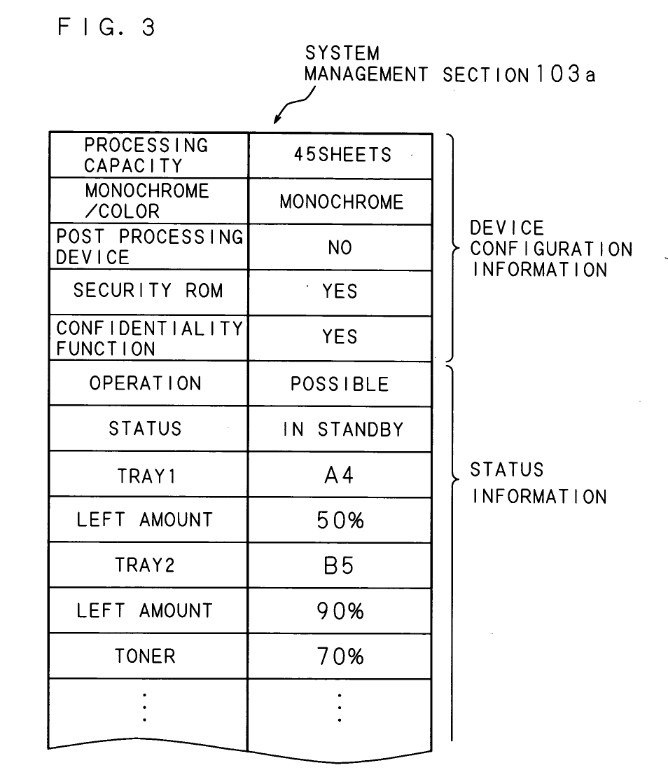

FIG. 3 is a conceptual diagram showing an example of the system management table 103a. The system management table 103a is classified mainly into device configuration information and status information. The device configuration information includes information such as number of sheets on which image is formed per minute (processing capacity), possibility of color printing, availability of a unit that performs a post processing of a stapler process etc., availability of the security ROM 112a, and the confidentiality function. Moreover, the status information includes information related to internal condition of the printer such as progress of the received printing job, amount of papers left in each paper feeding tray, and an amount of toner left. Further, the device configuration information and the status information may include information other than the information mentioned above, for example, information related to the encryption and invalidating of data may be included instead of the information related to the availability of security ROM 112a.

The system management table 103a shown in FIG. 3 indicates that the printer device 100A has the processing capacity of performing monochrome printing on 45 sheets per minute, a post processing unit is not installed, the security ROM 112a is installed in the ROM installing section 112, and has the confidentiality function. Moreover, it shows that in the current situation, the printer device 100A is in standby state, an amount of papers left in a tray that accommodates A4 size papers is 50%, an amount of papers left in a tray that accommodates B5 size papers is 90%, and an amount of toner left is 70%.

The controlling section 101 of the printer device 100A acquires the device configuration information and the status information by performing communication with each section of the hardware at every predetermined interval of time when the power supply is put on and during the operation, and updates the system management table 103a when there is a change in the device configuration or the status. Moreover, when there is a request from the management server 200 or the client apparatuses 300A and 300B, the information stored in the system management table 103a is transmitted to a requester of the request.

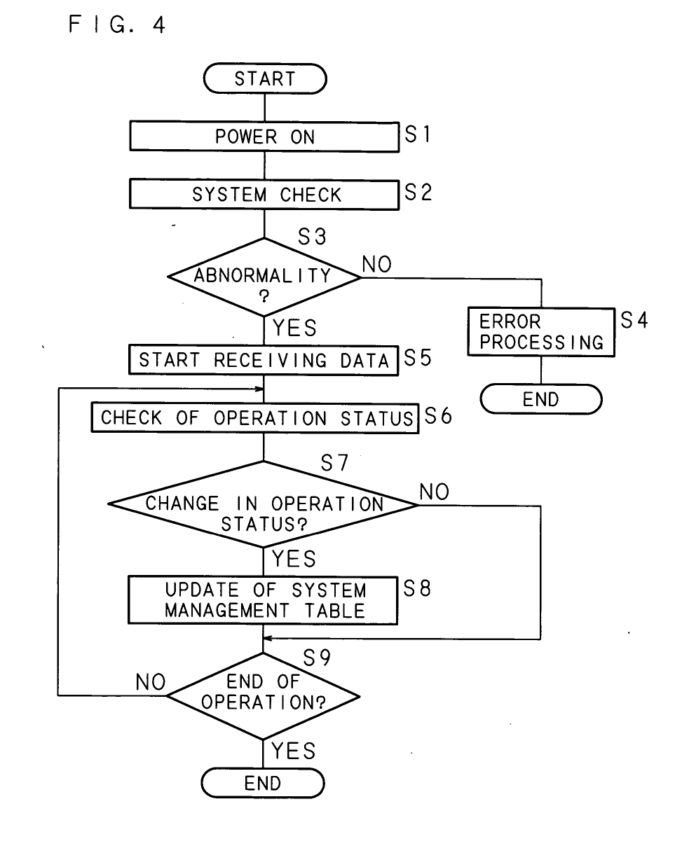

FIG. 4 is a flow chart describing a process while updating the system management table 103a. To start with, when the power supply of the printer unit 100A is put on (step S1), the controlling section 101 performs a system check by performing communication with each section of the hardware (step S2), and makes a judgment of whether there is an abnormality in any section of the hardware (step S3). At this time, the controlling section 101 acquires the device configuration information by detecting the availability of the security ROM 112a, and updates the information when there is a change in the system management table 103a.

When an abnormality is judged to be there at step S3, (NO at step S3), an error processing is performed (step S4) and an occurrence of an error is displayed on the display section 106. Moreover, when no abnormality is judged to be there at step S3 (YES at step S3), each section of the hardware is warmed up and receiving of data is started at the operating section 105, the image reading section 107, and the communication section 109 (step S5).

Next, the controlling section 101 performs a check of an operation status of each section of the hardware (step S6), and makes a judgment of whether there is a change in the operation status by referring to the status information of the system management table 103a (step S7), and when there is a change in the operation status (YES at step S7), the controlling section 101 updates the system management table 103a (step S8). Moreover, when there is no change in the operation status (NO at step S7), the controlling section 101 does not update the system management table 103a and executes the next process.

Next, the controlling section 101, by making a judgment of whether or not there has been a forced interruption due to resetting or cutting of the power supply of the printer device 100A, makes a judgment of whether or not the overall operation is ended (step S9), when a judgment of the overall operation not ended is made (NO at step S9), process from step S6 to step S8 is repeated, the operation of each section of the hardware is checked periodically, and when a judgment of the overall operation ended is made (YES at step S9), the process by this flow chart is completed.

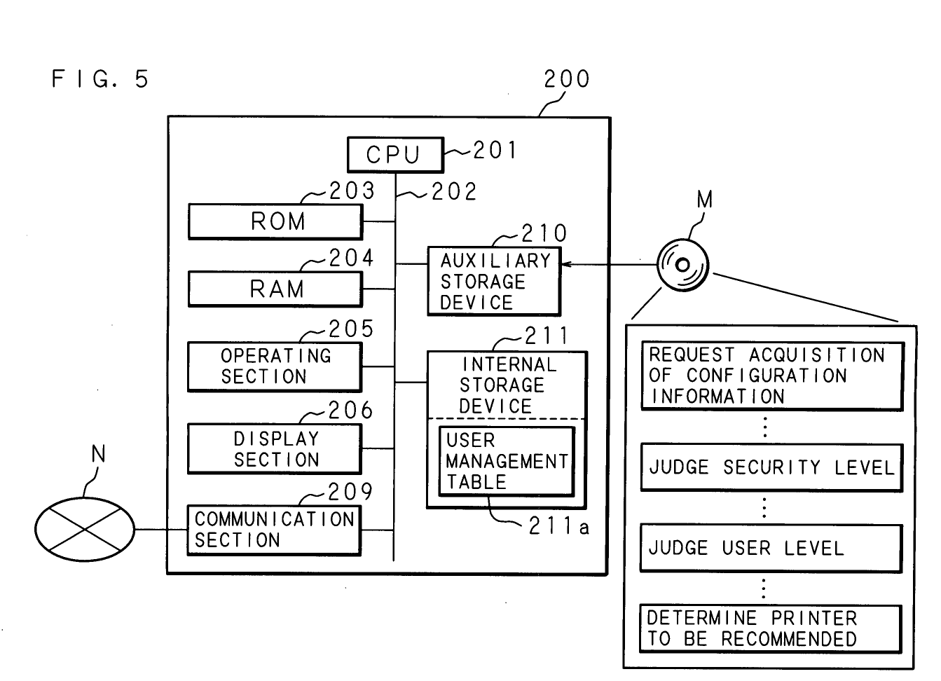

FIG. 5 is a block diagram describing an internal configuration of the management server 200. The management server 200, concretely, is a personal computer or a work station and includes a CPU 201 for controlling each section of a hardware that is described later. A ROM 203, a RAM 204, an operating section 205, a display section 206, a communication section 209, an auxiliary storage device 210, and an internal storage device 211 are connected to the CPU 201 via a bus 202, and by reading and executing a control program that is stored in advance in the ROM 203, control of each section of the hardware is executed. Moreover, various data that is generated during the execution of the control program and data that is inputted via the operating section 205 and the communication section 209 are stored temporarily in the RAM 204.

The operating section 205 includes input members such as a keyboard, a mouse, and a tablet, and receives instructions from a manager that is a user of the management server 200. The display section 206 includes a display unit such as a CRT display and a liquid crystal display, and displays information that is inputted via the operating section 205 and information that is inputted via the communication section 209. The communication section 209 has a communication interface that conforms to communication standards of the communication network N and controls the transmission and receiving of data that is transmitted between the printer device 100 and the client apparatuses 300A and 300B that are connected via the communication network N.

The auxiliary storage device 210 is a reading unit for reading a computer program from a memory medium M such as an FD and a CD-ROM in which a computer program of the present invention is stored, and the read computer program is stored in the internal storage device 211 such as an HDD device. The computer program stored in the internal storage device 211 is loaded to the RAM 204 at the time of execution and is executed by the CPU 201. By execution of the computer program the management server 200 operates as an information processing apparatus according to the present invention.

Moreover, a part of a storage area of the internal storage device 211 is used as a user management table 211a in which information related to the user of the client apparatuses 300A, 300B, and 300C is stored, and is referred to while determining the printer device 100 to be recommended to the user of the client apparatus 300C, which is connected newly to the communication network N.

Furthermore, the internal storage device 211 stores the printer driver of each of the printer devices 100A to 100D and can provide according to a request from the client apparatuses 300A to 300C.

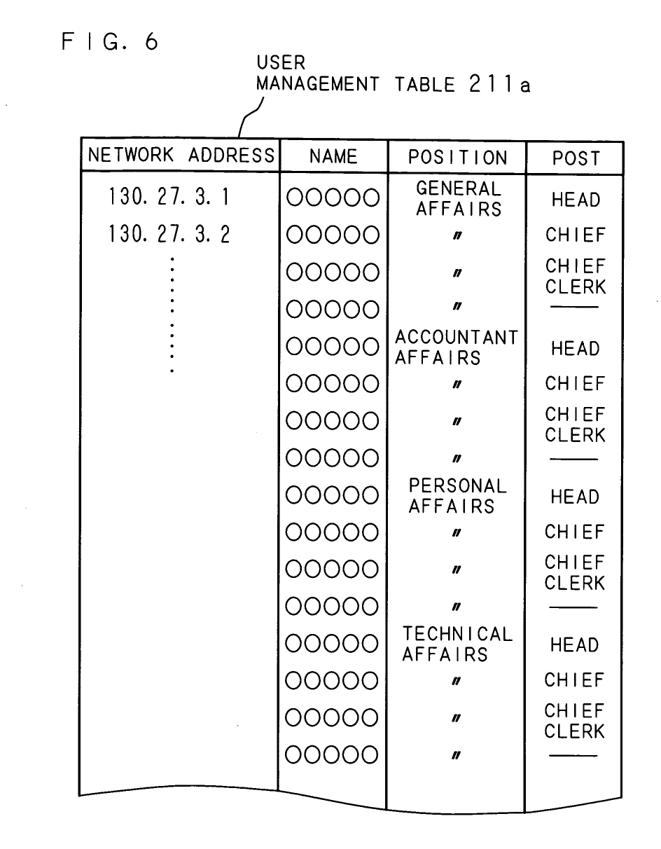

FIG. 6 is a conceptual diagram showing an example of the user management table 211a. The user management table 211a associates and stores identification information (for example network address such as an IP address) for identifying the client apparatuses 300A, 300B, and 300C over the network N and information related to a user such as user's name, position, and post. Therefore, when there is an access from the client apparatuses (300A to 300C) over the communication network N to the management server 200, it is possible to acquire in the management server 200, the information such as the name, position, and post of a user who uses that client apparatus (300A to 300C). Further, when the new client apparatus 300C is to be connected to the communication network N, the network address and the information of the user is associated and recorded in advance.

Moreover, the management server 200 manages the device configuration information of the printer devices 100A to 100D, and holds the latest device configuration information all the time by making a request for acquiring the device configuration information to each of the printer devices 100A to 100D according to the requirement.

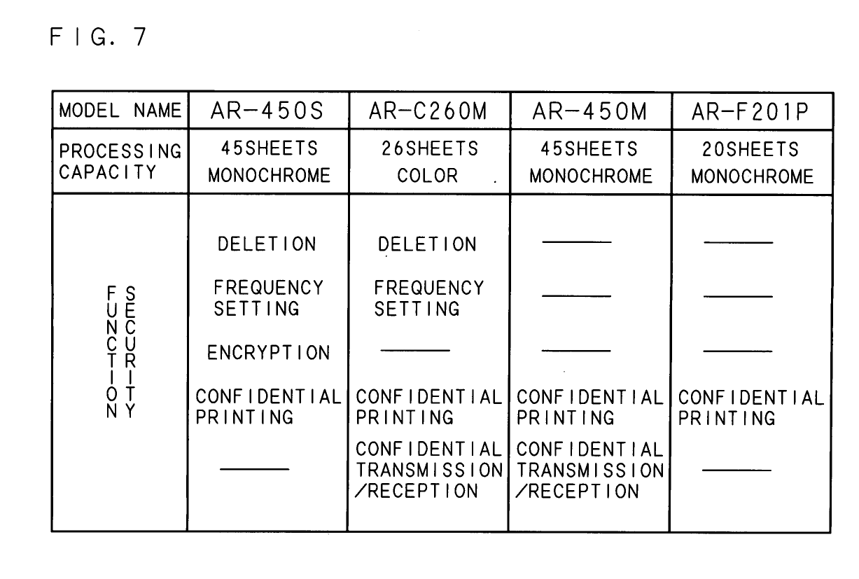

FIG. 7 is conceptual diagram showing a list of device configuration information in the management server 200. The management server 200 stores in the internal storage device 211 information related to a model name, processing capacity, and security function of the printer devices 100A to 100D as the device configuration information to be managed internally. Regarding the processing capacity, information related printing speed and possibility of color printing is stored. Moreover, regarding the security function, detailed information of a process executed by the security ROM 112a and information related to the confidentiality function is stored.

For example, information such as a printer device (100A) which has a model name AR-450S has a processing capacity of 45 monochrome prints per minute, can perform invalidating (deletion) of data, frequency setting of invalidating process, and encryption of data as a process executed by security ROM 112a, and moreover can receive an execution request of confidential printing, is stored. Moreover, in other device configuration information, information of a model name (AR-C260M) in which invalidating (deletion) of data and the frequency setting can be performed, but data protection by encryption can not be performed, a model name (AR-450M) that does not have a function to protect data by invalidating and encrypting the data but can perform confidential transmission and reception in confidential printing and facsimile transmission, and model name (AR-F210P) that receives only an execution request for confidential printing, is stored.

In the present embodiment, when it is a newly connected client apparatus 300C, the management server 200 refers to the user management table 211a and information related to security function for the device configuration information and selects the printer device 100 to be recommended for use to the user of the client apparatus 300C, and the selected information is provided to the client apparatus 300C.

Concretely, when there is a request for acquisition of the printer driver from the client apparatus 300C, the management server 200, to start with, makes a judgment of a security level of each of the printer devices 100A to 100D. The security levels can be classified in a number of stages according to the capacity to protect the data. In the present embodiment, the security level is classified into three stages, and a printer device that has no security function for data at all, or a printer device that has a confidentiality function but no function for data invalidating process and data encrypting process is let to have a security level zero, and the printer device is judged to be belonging to a low level of capacity to protect data. Moreover, a printer device that has a confidentiality function and for which the data invalidating process can be executed, but the data encrypting process cannot be performed is let to have a security level one, and the printer device is judged to be belonging to a comparatively high level of capacity to protect data. Furthermore, a printer device that has all of the confidentiality function, the invalidating process function, and the encrypting process function is let to have a security level two, and the printer device is judged to be belonging to the highest level of capacity to protect data.

In the example shown in FIG. 7, the security level of model name AR-450S is two, the security level of model name AR-C260M is one, and the security level of model name AR-450M and AR-F201P is zero.

Moreover, the management server 200 makes a judgment of the security level of data handled by the user (hereinafter, “user level”). As described earlier, since the management server 200 has the user management table 211a in which the network address and the information related to that user is associated and stored, it is possible to acquire the information related to the user of the connected client apparatus 300C. In the present embodiment, the user level is classified into three stages based on an official post of the user. For example, when the user is a head, the user level is let to be two and data handled by this user is judged to have high confidentiality. At this time, the management server 200 recommends a printer device 100 having a security level two to that user. Moreover, when the user is a chief, the user level is let to be one and data handled by this user is judged to have somewhat high confidentiality. At this time, the management server 200 recommends a printer device 100 having a security level one to that user. Furthermore, when the user is neither a head nor a chief, the user level is let to be zero and data handled by this user is judged to have low confidentiality. At this time, the management server 200 recommends a printer device 100 having a security level zero to the user.

When there is a plurality of printer devices 100 having the same security level over the communication network N, a printer device having a high processing capacity may be recommended or a plurality of printer devices 100 may be recommended.

Moreover, a method for classification of the security level of each of the printer devices 100A to 100D and the security level of data handled by the user is not restricted to the method described earlier and the manager of the management server 200 may be let to voluntarily set it in advance.

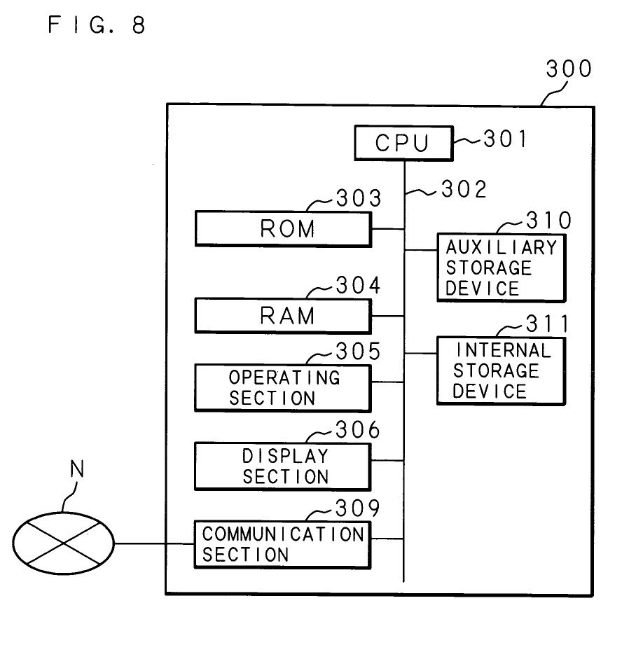

FIG. 8 is a block diagram describing an internal configuration of the client apparatus 300C. The client apparatus 300C, concretely, is a personal computer or a work station and includes a CPU 301 for controlling each section of hardware that is described later. A ROM 303, a RAM 304, an operating section 305, a display section 306, a communication section 309, an auxiliary storage device 310, and an internal storage device 311 are connected to the CPU 301 via a bus 302, and by reading and executing a control program that is stored in advance in the ROM 303, control of each section of the hardware is executed.

A printer search program for searching a printer device 100 that is over the communication network N is installed in advance in the internal storage device 311 of the client apparatus 300C, and by starting the printer search program according to the requirement, information related to the printer device 100 over the communication network N can be acquired. In the present embodiment, the client apparatus 300C does not acquire the information by performing communication directly with the printer device 100, but acquires information that is provided from the management server 200 by making an access to the management server 200. The information provided by the management server 200 includes information related to a printer device 100 to be recommended for use as described earlier.

An operation when the client apparatus 300C is connected over the communication network N is described below by showing concrete examples of a screen.

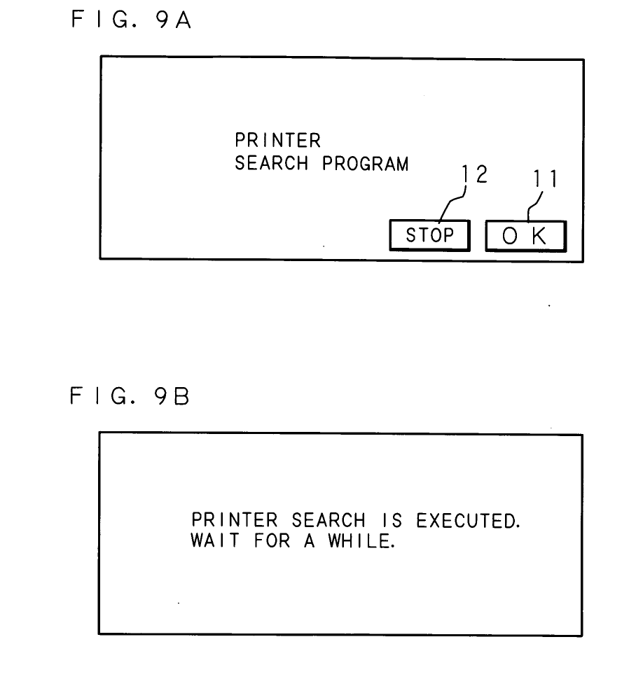

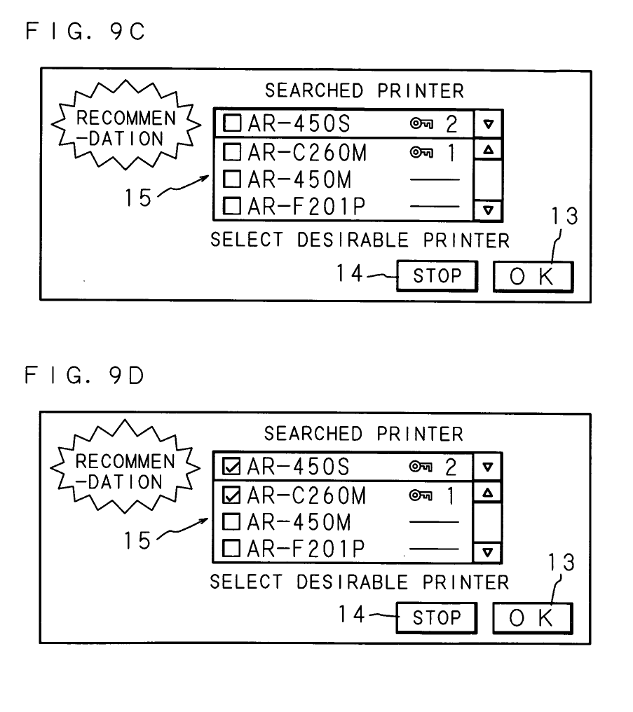

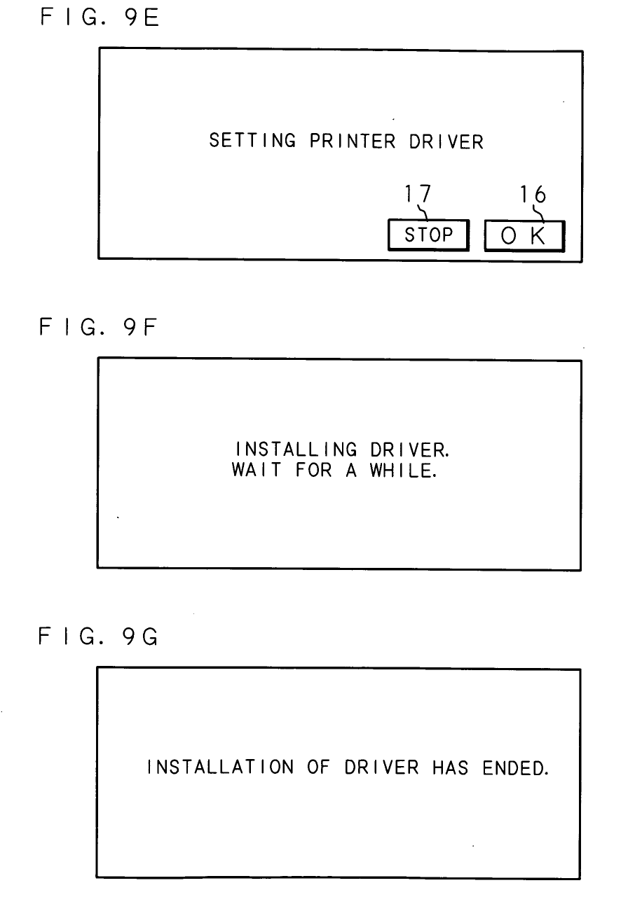

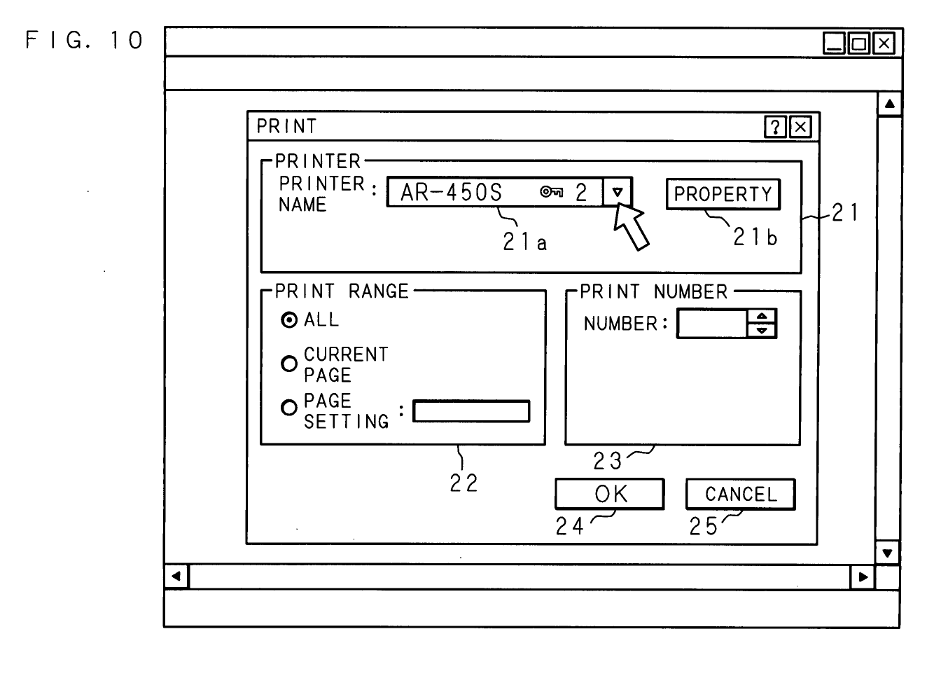

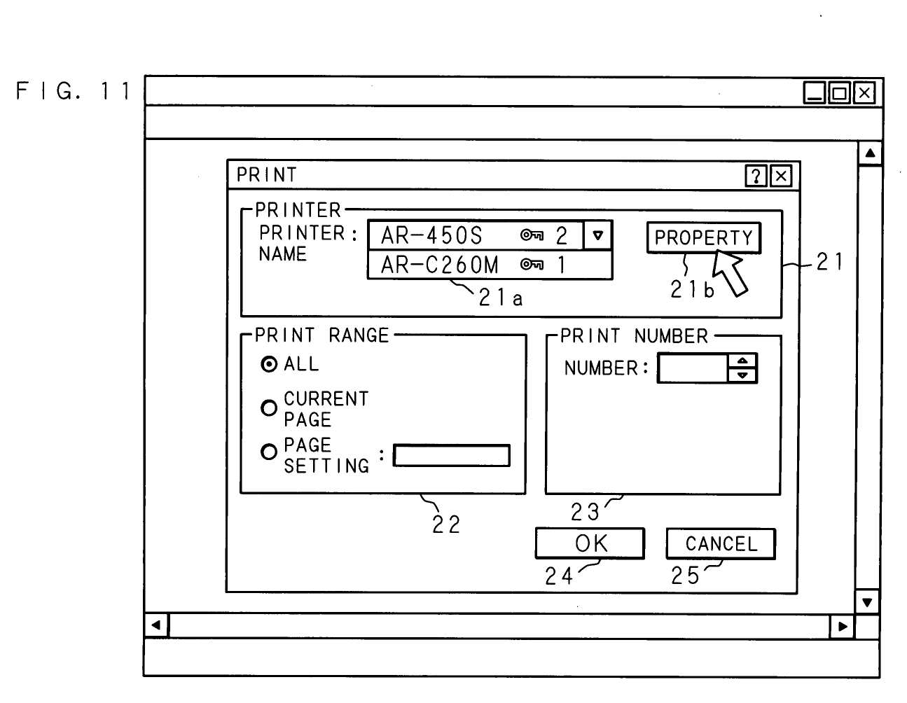

FIGS. 9A to 9G are schematic diagrams describing an operation in a printer search program that is installed in the client apparatus 300C. When the client apparatus 300C is connected to the communication network N and the printer search program mentioned earlier is started, a program screen shown in FIG. 9A is displayed on the display section 306 of the client apparatus 300C. In this state, when an execution key 11 at a right corner of the screen is pressed by a mouse of the operating section 305, the program screen changes to a screen shown in FIG. 9B and a request for acquisition of a printer driver is made from the client apparatus 300C to the management server 200. Further, when a stop key 12 on the program screen in FIG. 9A is pressed, the request for acquisition of the printer driver is not made and the printer search program ends.

Further, when printer information is transmitted from the management server 200, the printer search program displays the printer information on the program screen (refer to FIG. 9C). In an example shown in FIG. 9C, model names of four models described earlier are displayed as well as AR-450S displayed at a top is displayed as a recommended printer device 100. Moreover, by a schematically shown key mark, it is displayed that models AR-450S and AR-C260M have security function and a security level of these printer devices 100 is expressed in number on a right side of the key mark.

Moreover, a check box 15 is provided on a left side of each model name and by checking the check box 15 by using the operating section 305, a printer device 100 desired by the user can be selected (refer to FIG. 9D).

After one or a plurality of printer devices 100 is selected, when an execution key 13 is pressed, the selected information is transmitted to the management server 200, and when a stop key 14 is pressed, the selected information is not transmitted and the program screen shown in FIG. 9A returns.

When the selected printer driver of the printer device 100 is transmitted from the management server 200, the program screen changes to a screen shown in FIG. 9E and a preparation for setting the printer is made. Then, when an execution key 16 is pressed, installation of the printer driver starts practically and the program screen changes to a screen shown in FIG. 9F. When the installation ends, end of installation is displayed on the program screen (refer to FIG. 9G). Further, when a stop key 17 is pressed on the program screen in FIG. 9E, the printer driver is not installed and the process is completed by the printer search program.

The printer device 100 thus selected can be selected from a printer setting screen while performing the printing practically. FIG. 10 to FIG. 13 are schematic diagrams showing print-setting screen. When image data and document data created in the client apparatus 300C are to be printed, a printing job is generated by the printer driver and a request for execution of the printing job can be made to the selected printer device 100.

When the printing job is generated, the print-setting screen shown in FIG. 10 is displayed on the display section 306. The print-setting screen includes a printer setting section 21 that performs a setting for the printer unit 100 that is used, a print-range setting section 22 that performs a setting of a print range, and a print-copies setting section 23 that performs a setting of a number of copies to be printed. Here, when an execution key 24 is pressed, a printing job is generated practically and the printing job is transmitted to the printer device 100 selected in the printer setting section 21. Moreover, when a cancel key 25 is pressed, the printing job is not generated and the setting of prints ends.

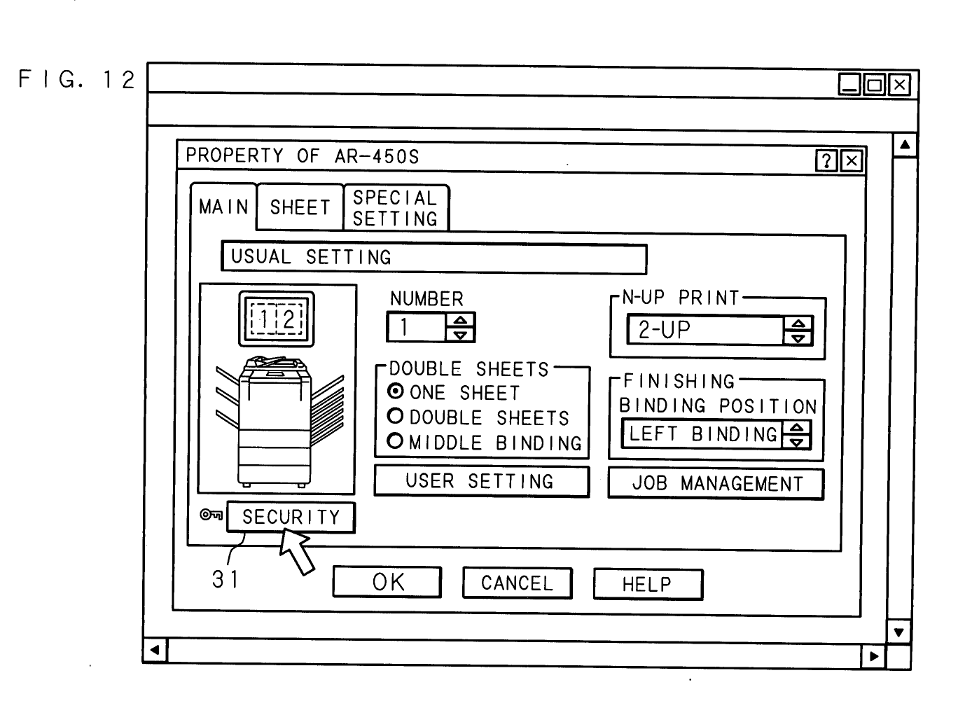

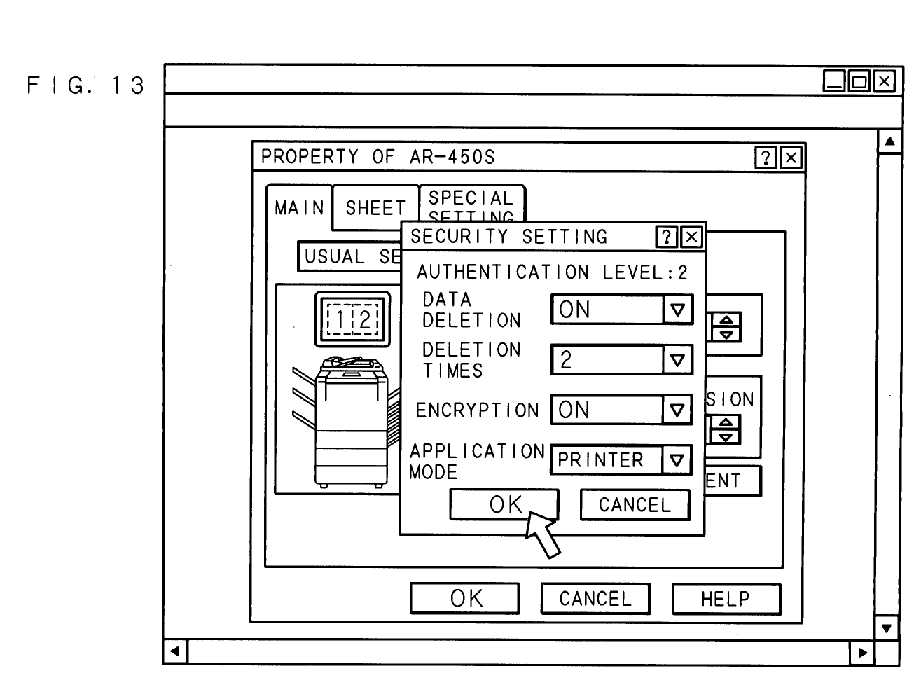

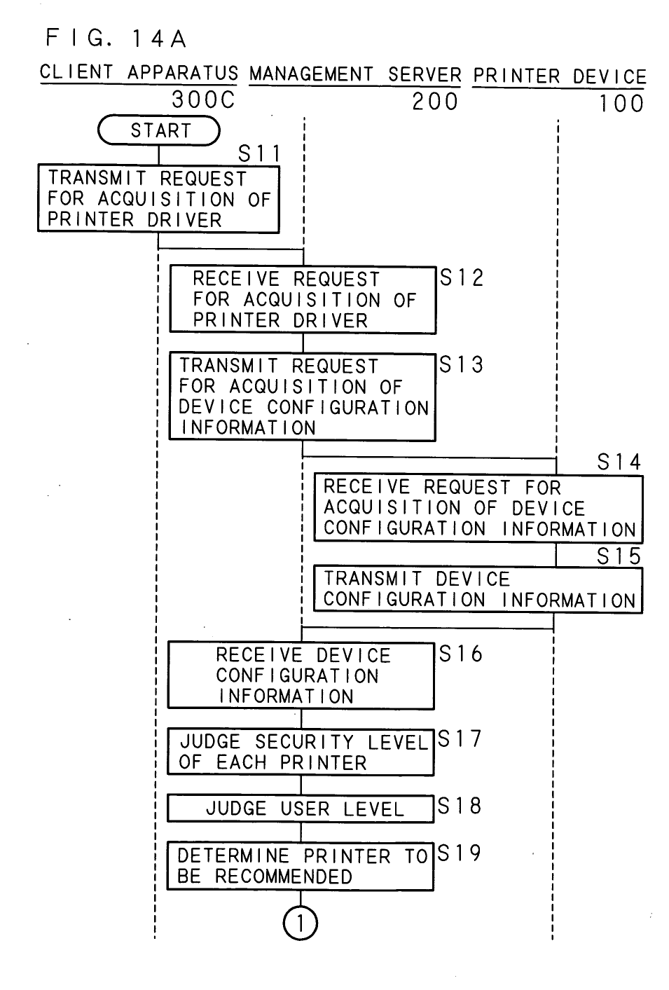

A printer selection column 21a for selecting a printer device 100 to be used and a property button 21b for setting details of the printing process are disposed in the printer setting section 21. Model names of printer devices 100 that can be used practically and security level of these printer devices are displayed in the printer selection column 21a (refer to FIG. 11). Moreover, when the property button 21b is pressed, the print-setting screen changes to a screen shown in FIG. 12 and various settings related to printing process can be performed. In the present embodiment, even for the security function various settings can be performed and when a security button 31 is pressed, a security setting screen is displayed (refer to FIG. 13).

On the security setting screen, setting of availability of execution of a deletion process, setting of frequency of deletion of data, availability of execution of an encrypting process, and an applicable mode can be performed.

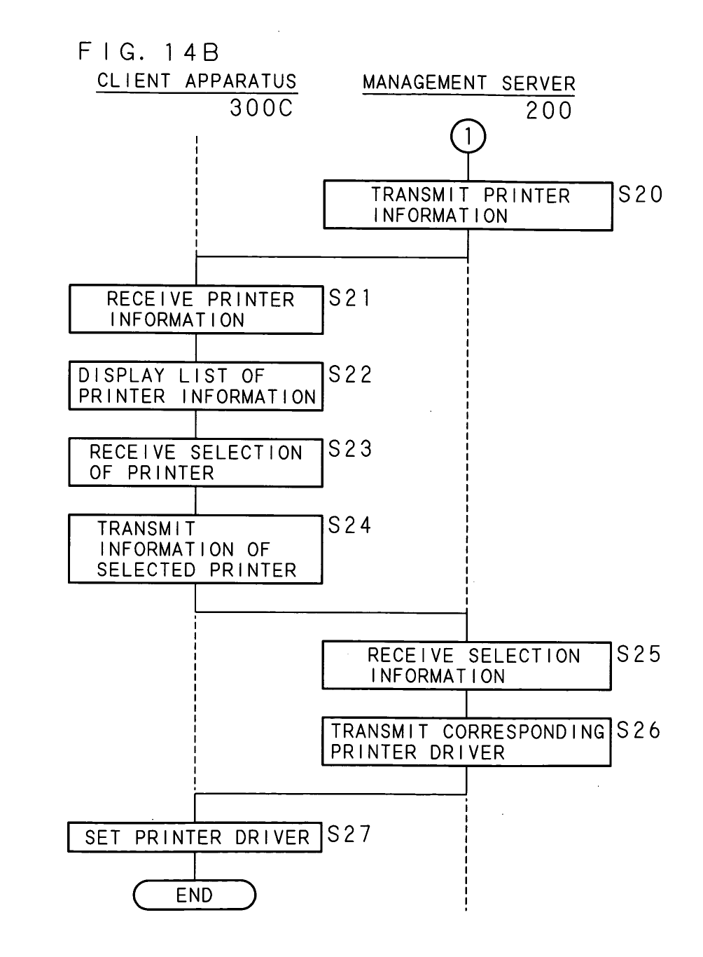

FIGS. 14A and 14B are flow charts describing a processing procedure of the information processing system according to the present embodiment.

To start with, the client apparatus 300C transmits a request for acquisition of the printer driver to the management server 200 by starting the printer search program that is described earlier (step S11). When the management server 200 receives the request for acquisition of the printer driver that is transmitted from the client apparatus 300C (step S12), the management server 200 transmits a request for acquisition of the device configuration information to the printer device 100 (step S13). Then, when the printer device 100 receives the request for acquisition of the device configuration information (step S14), the printer device 100 extracts device configuration information of each of printer devices 100A to 100D from the system management table 103a and transmits to the management server 200 (step S15).

When the management server 200 receives the device configuration information transmitted from each of the printer devices 100 (step S16), the management server 200 makes a judgment of a security level of each of the printer devices 100A to 100D based on information related to the security function included in the device configuration information (step S17). Next, the management server 200 refers to the user management table 211a and makes a judgment of a user level of the user of the client apparatus 300C (step S18), and determines a printer device 100 to be recommended according to the user level (step S19). Then, the management server 200 transmits printer information that includes information of the printer device to be recommended to the client apparatus 300C (step S20).

When the client apparatus 300C receives the printer information (step S21), a list of printer information that is searched as shown in FIG. 9C is displayed on the display screen 306 (step S22), and the client apparatus 300C receives a selection of printer device 100 (step S23). Then, the client apparatus 300C transmits information of the selected printer device 100 (selection information) to the management server 200.

When the selection information is received by the management server 200 (step S25), the management server 200 transmits a corresponding printer driver to the client apparatus 300C (step S26). Next, when the client apparatus 300C receives the printer driver, the client apparatus 300C performs setting of the printer driver (step S27).

Further, in the present embodiment, although the structure is such that when the request for acquisition of the printer driver is received from the client apparatus 300C, the request for acquisition of the device configuration information is transmitted to each of the printer devices 100, when a structure is such that the management server 200 periodically performs communication with the printer device 100 and the latest device configuration information is held all the time in the internal storage device 211, a judgment of security level may be made by using the device configuration information stored in the internal storage device 211 without performing process from step S12 to step S16.

### INDUSTRIAL APPLICABILITY

According to the present invention, when a search request for information device to be used is received via a communication line, an information device to be recommended for use according to a requester of the search request is selected based on device information stored in advance, and device information of the selected information device is transmitted to the requester. Therefore, it is possible to provide an information device that is suitable for the requester of the search request, and to check easily an existence of the suitable information device without checking each information device on a search request side.

According to the present invention, since the information device to be recommended for use is selected based on device information and user information related to a user of a second information processing apparatus, it is possible to provide a suitable information device to the user and to check easily an information of the suitable information device without checking each information device via the communication line, even on a user's side.

According to the present invention, information related to a security function for information to be processed is included in the device information. Therefore, it is possible to provide a suitable information device according to a confidentiality of information that is handled by the user and to acquire information about the information device without checking each information device that has a security function for information, even on the user's side.

According to the present information, setting information such as a driver program that is to be set while using the information device, is stored and transmitted according to the requirement. Therefore, it is possible to acquire information of a suitable information device without checking each information device via the communication line on the user's side, as well as to acquire easily setting information required while using that information device.

According to the present invention, means for performing an image forming based on image data received by the information device is included. Therefore, for an image forming apparatus such as a printer that is connected to the communication line, it is possible to provide suitable information for use by the user and to acquire easily information of an image forming apparatus that suits user's object, without checking each image forming apparatus via the communication line, even on the user's side.

According to the present invention, the information device includes means for transferring image data that is created upon reading an image on a document. Therefore, for an image reading apparatus such as a network scanner connected to the communication line, it is possible to provide information suitable for use by the user and to acquire easily information of an image reading apparatus that suits user's object without checking each image reading apparatus via the communication line, even on the user's side.

1-13. (canceled)

14. A method of information processing in which device information of one or plurality of information devices is stored and the device information is transmitted according to a request received from outside, comprising the steps of:
receiving a search request for information device;
selecting an information device to be recommended for use to a requester of received search request based on the stored device information; and
transmitting device information of the selected information device to the requester.

15. An information processing system comprising:
a first information processing apparatus;
a second information processing apparatus;
one or a plurality of information devices; and
a communication line for connecting said first information processing apparatus, said second information processing apparatus, and said information device, wherein
said second information processing apparatus includes a search request transmitting section that transmits a search request for searching an information device to be used to said first information processing apparatus, and
said first information processing apparatus includes a device information storage section that stores device information related to said information device, a receiving section that receives the search request transmitted from said second information processing apparatus, a selecting section that selects an information device to be recommended for use according to the received search request based on device information stored in said device information storage section, and a device information transmitting section that transmits device information of the selected information device to said second information processing apparatus.

16. The information processing system according to claim 15, wherein
said first information processing apparatus further includes a user information storage section that stores user information related to a user of said second information processing apparatus,
and said selecting section selects an information device to be recommended based on the said user information and the device information stored in said device information storage section.

17. The information processing system according to claim 15, wherein
the device information includes information related to a security function for information to be processed by information device.

18. The information processing system according to claim 16, wherein
the device information includes information related to security function for information to be processed by information device.

19. The information processing system according to claim 15, wherein
said first information processing apparatus further includes a setting information storage section that stores setting information to be set when said second information processing apparatus uses said information device and a setting information transmitting section that transmits the setting information to said second information processing apparatus.

20. The information processing system according to claim 15, wherein said information device includes a receiving section that receives image data and an image forming section that performs image forming on a sheet based on the received image data.

21. The information processing system according to claim 15, wherein
said information device includes a creating section that creates image data by reading an image on a document and an image data transmitting section that transmits the created image data to outside.

22. An information processing apparatus that can be connected to one or a plurality of information devices via a communication line, comprising:
a storage section that stores device information related to the connected information device;
a receiving section that receives a search request for an information device;
a selecting section that selects an information device to be recommended for use according to a requester of the search request based on device information stored in said storage section; and
transmitting section that transmits device information of the selected information device to the requester.

23. A memory medium readable by a computer in which a computer program is recorded, causing the computer to transmit information related to information device stored in advance based on a received request, said memory medium storing a computer program causing the computer to execute the steps of:
causing the computer to select an information device to be recommended for use according to a requester of a received search request for information device based on the stored device information; and
causing the computer to transmit device information of the selected information device to the requester.

24. The memory medium according to claim 23, wherein
the data information includes information related to a security function for information to be processed by information device.

25. A memory medium readable by a computer in which a computer program is recorded, causing the computer to transmit information related to information device stored in advance based on a received request, said memory medium storing a computer program causing the computer to executes the steps of:
causing the computer to select an information device to be recommended for use according to a requester of a received search request for information device based on user information of the requester and the device information stored in advance; and
causing the computer to transmit device information of the selected information device to the requester.

26. The memory medium according to claim 25, wherein the data information includes information related to a security function for information to be processed by an information device.
